(19) United States
(12) Patent Application Publication
(10) Pub. No.: US 2020/0037603 A1
(43) Pub. Date: Feb. 6, 2020

(54) PEST DETERRENT AND/OR ALERT ASSISTANT DEVICE

(71) Applicant: Veronica L. Felton-Armouti, Edwardsville, IL (US)

(72) Inventor: Veronica L. Felton-Armouti, Edwardsville, IL (US)

(21) Appl. No.: 16/527,845

(22) Filed: Jul. 31, 2019

Related U.S. Application Data
(60) Provisional application No. 62/713,616, filed on Aug. 2, 2018.
(60) Provisional application No. 62/748,056, filed on Oct. 19, 2018.

(51) Int. Cl. A01M 29/16; A01K 15/02; A01M 29/12; A01M 31/00

(52) U.S. Cl. CPC A01M 29/16; A01M 31/002; A01M 29/12; A01K 15/02

(57) ABSTRACT

A pest deterrent device includes one or more sensors configured to detect a presence of a pest, a controller configured to determine that the pest is detected based on output from the one or more sensors, a repelling array configured to generate a repellant in response to the controller determining that the pest is detected, and a communications array configured to wirelessly communicate with an external device. The communications array is configured to communicate with the external device to change a type of the repellent that is generated in response to the pest being detected.

### CROSS-REFERENCE TO RELATED APPLICATIONS

This application claims priority to U.S. Provisional Application No. 62/713,616, filed 2 Aug. 2018, and U.S. Provisional Application No. 62/748,056, filed 19 Oct. 2018, the entire disclosures of which are incorporated herein by reference.

### BACKGROUND

### Technical Field

The subject matter described herein relates assemblies that deter pests such as animals from locations and/or that generate alerts based on a detected presence of a pest or person in a location.

### Discussion of Art

Some known devices attempt to deter pests from locations using a variety of techniques. For example, chemicals may be added to the ground or plants to deter animals from entering locations with the chemicals and/or eating plants. Automated lights or water sprinklers can be used to turn on lights or a flow of water to scare pests away. Some devices include a motion detector and speaker to play sounds to scare pests away. These devices include a switch, knob, or other device that is manually actuated by a user to change what sounds are played in response to detecting motion. But, these devices require the user to travel to the location of the device to manually change which sound is played, to change the volume, etc. These devices can be inconvenient to use when the devices are located in a remote location or a location that is not frequently traveled to by the owner or user.

But, these types of devices are limited in their ability to detect the pests and the responses that can be provided. As a result, many pests may not be detected and/or may become accustomed to the chemicals, lights, or water that is used to drive the pests away from an area.

### BRIEF DESCRIPTION

In one embodiment, a pest deterrent device includes one or more sensors configured to detect a presence of a pest, a controller configured to determine that the pest is detected based on output from the one or more sensors, a repelling array configured to generate a repellant in response to the controller determining that the pest is detected, and a communications array configured to wirelessly communicate with an external device. The communications array is configured to communicate with the external device to change a type of the repellent that is generated in response to the pest being detected.

In one embodiment, a pest deterrent device includes an outer housing and an infrared (IR) sensor disposed on or within the outer housing. The IR sensor is configured to detect heat indicative of a pest. The pest deterrent device also includes one or more processors disposed in the outer housing and configured to detect a presence of the pest based on the heat detected by the IR sensor, a repellant device configured to generate a repellant responsive to the presence of the pest being detected, and a communication device configured to wirelessly communicate with a mobile device. The communication device is configured to receive instruction from the mobile device to remotely change the repellant that is generated by the repellant device responsive to the presence of the pest being detected.

In one embodiment, a method includes detecting a presence of a pest outside of an outer housing of a pest deterrent device using an infrared (IR) sensor, generating a repellant in response to detecting the presence of the pest, and wirelessly communicating with an external device to remotely change the repellant that is generated in response to detecting the presence of the pest.

### BRIEF DESCRIPTION OF THE DRAWINGS

FIG. 1 is a front perspective view of one embodiment of a pest deterrent and/or alert assistant device.

FIG. 2 is a rear perspective view of the deterrent device shown in FIG. 1.

FIG. 3 is a side view of the deterrent device shown in FIG. 1.

FIG. 4 is a front view of the deterrent device shown in FIG. 1.

FIG. 5 is another front view of the deterrent device shown in FIG. 1 with activated lamps or lights in eyes of the dog represented by the device.

FIG. 6 is a partial exploded view of the device shown in FIG. 1.

FIG. 7 is a schematic illustration of the device shown in FIG. 1.

FIG. 8 illustrates a flowchart of one embodiment of a method for detecting and responding to the presence of a pest.

### DETAILED DESCRIPTION

One or more embodiments of the inventive subject matter described herein provide for an electro-mechanical and/or micro-electro-mechanical adjustable sensing and networking device for pest deterrence and alert assistance. The pest can include an animal, person, or the like. The device placed in or on the ground in areas to deter pests from damaging gardens, crops, landscaping, and the like. The device also can be used to deter pests from leaving droppings and/or from discouraging intrusions from dangerous pests. The device can alert users regarding activity in remote or isolated areas on a property and may alert users of intrusions while engaging in outdoor activities in secluded areas. As described herein, the device can provide for a wide variety of communication abilities, movements, and other actions that deter pests from entering areas and/or that alert users of the entry of pests or people into locations.

The device can provide for motion sensing and temperature sensing, as well as a variety of communications (e.g., Wi-Fi capable, BLUETOOTH capable, cellular capable, etc.) and can be programmable as described herein. The device can produce a variety of sounds and include Global Positioning System (GPS) receivers to determine the location of the device. The device optionally can be a mesh networking device that allows for communication with other devices for pest deterrence and alert assistance over larger areas. The device can be housed in a three-dimensional ultraviolet (UV)-resistant molded opaque plastic, vinyl, and/or plastic resin. The device may be solar and/or battery powered, and may be formed in the shape of an animal replica that is mounted on a durable stake for placement in or on the ground in areas to deter pests from damaging gardens, crops, and landscaping; deter pests from leaving droppings; discourage intrusions from dangerous pests; alert users via sound regarding activity in remote or isolated areas on property; and alert users of intrusions while camping or engaging in outdoor activities in secluded areas.

The device can emit audible sound through speakers, move head, and/or flash lights when sensors are triggered (e.g., due to the presence of a pest or person nearby). The audible sound can be barking; growling; other predatory sounds; personally recorded messages; or sounds available via download, including but not limited to explosions or gunshots. Once activated, the sound will cycle off after a predetermined time interval. Multiple devices are capable of communicating with each other via a net interface (e.g., an Internet browser, mesh networking, cellular communications, or the like).

The device can allow for customization by programming recorded personal content, downloaded content, and/or the other available features. The device can retain usage and activation data that can be accessed by the owner (e.g., via an Internet browser, mobile app, etc.). The device can include a stake extension for added height above the ground, a stake base for use on non-porous surfaces such as concrete, and/or rechargeable batteries.

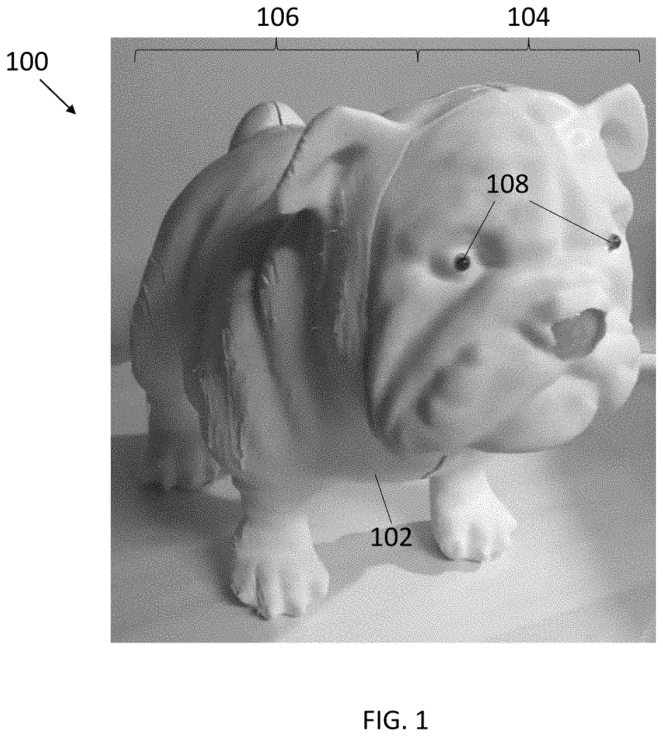

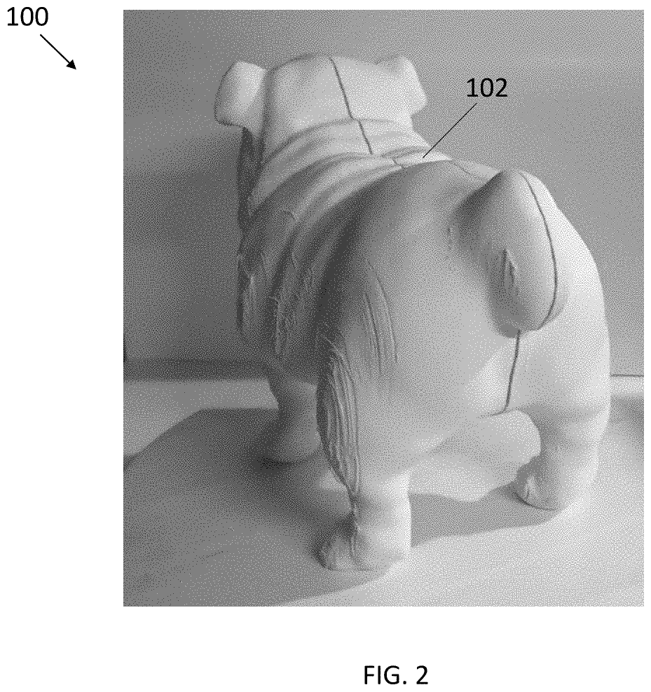

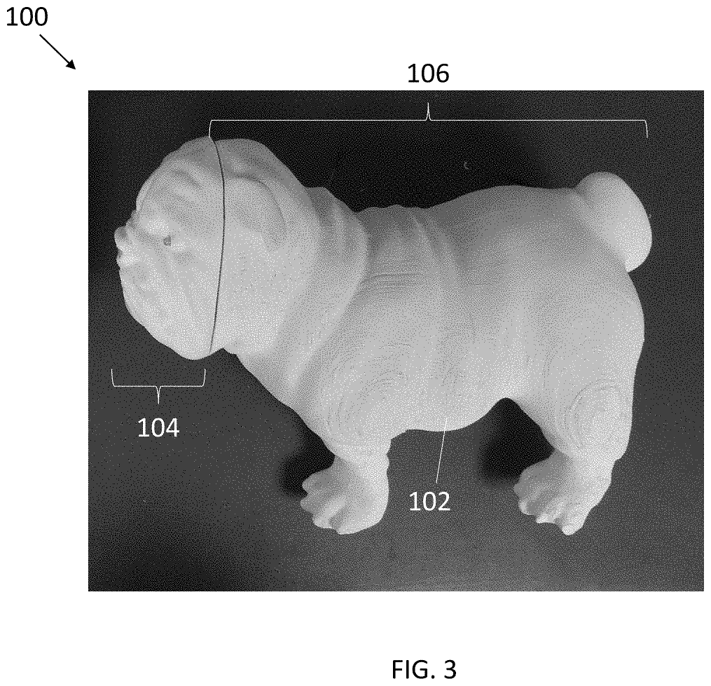

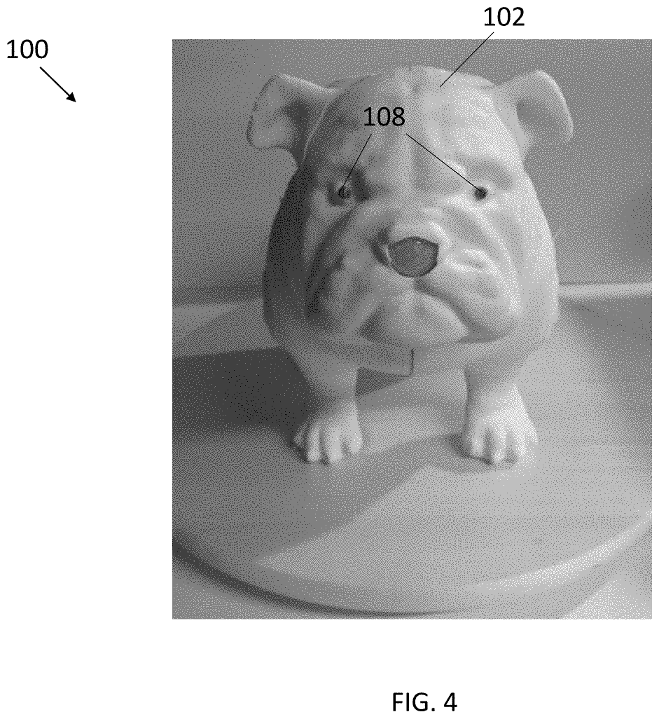

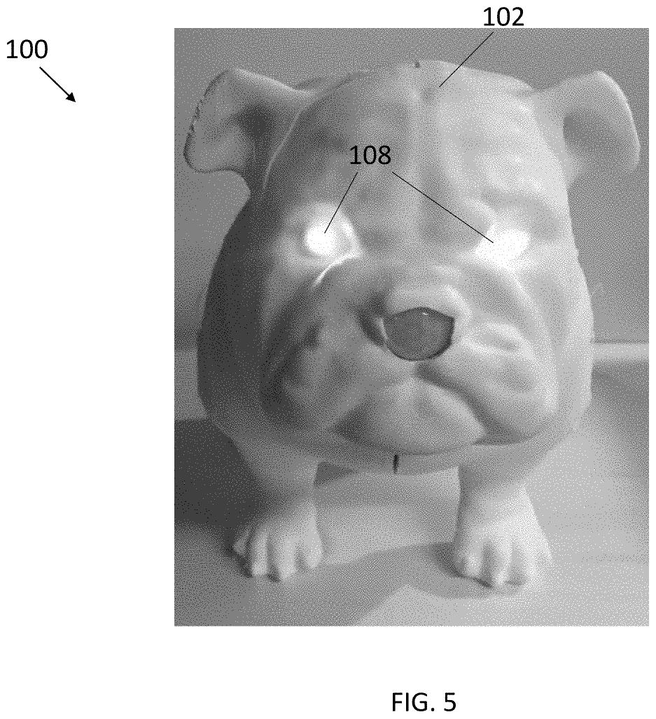

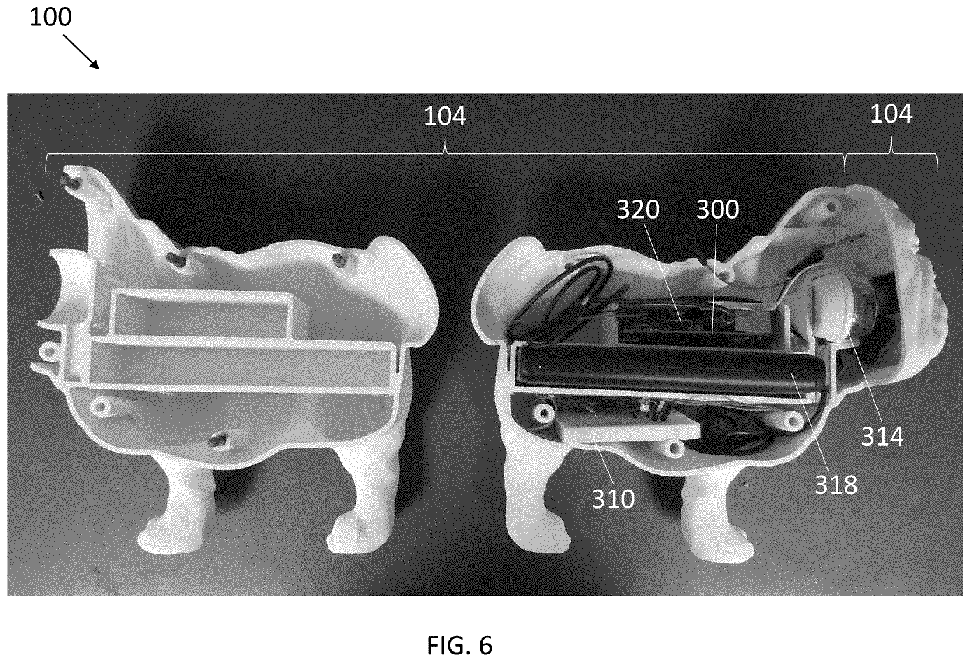

FIG. 1 is a front perspective view of one embodiment of a pest deterrent and/or alert assistant device 100. FIG. 2 is a rear perspective view of the deterrent device 100 shown in FIG. 1. FIG. 3 is a side view of the deterrent device 100 shown in FIG. 1. FIG. 4 is a front view of the deterrent device 100 shown in FIG. 1. FIG. 5 is another front view of the deterrent device 100 shown in FIG. 1 with activated lamps or lights in eyes of the dog represented by the device 100. FIG. 6 is a partial exploded view of the device 100 shown in FIG. 1. The device 100 has an outer housing 102 in the shape of a dog, but alternatively may have the shape of another animal (e.g., a deer, cat, bird, etc.) or the shape of another object (e.g., a box, a post, a sign, etc.). The housing 102 can be formed from a three-dimensional UV-resistant molded opaque plastic, vinyl, plastic resin, or the like. The housing 102 can mimic the appearance of another object, such as an animal, furniture, fixtures (e.g., a yard gnome), or other structures.

The outer housing 102 can be divided into segments 104, 106 that are coupled with each other yet that allow for movement of at least one segment 104 or 106 relative to the other segment 106 or 104. In the illustrated embodiment, the outer housing 102 is segmented between a head or face segment 104 and a body segment 106. The head or face segment 104 can be coupled with a motor 314 (shown in FIG. 6) in the body segment 106. This motor 314 can operate to rotate or otherwise move the head or face segment 104 relative to the body segment 106 of the housing 102. The housing 102 may be coupled with a post, stand, spike, or the like, for positioning the housing 102 in a desired location.

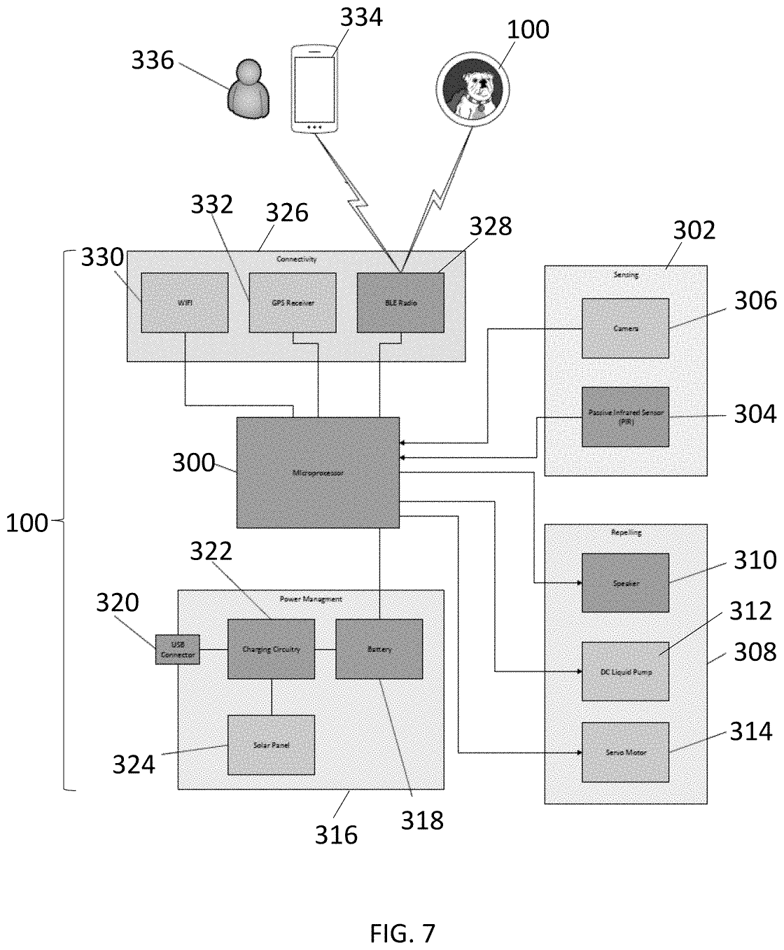

With continued reference to the device 100 shown in FIGS. 1 through 6, FIG. 7 is a schematic illustration of the device 100 shown in FIG. 1. The device 100 includes a controller 300 representative of hardware circuitry that includes and/or is connected with one or more processors that perform and/or control the operations described herein. The one or more processors can include one or more microprocessors, one or more integrated circuits, one or more field programmable gate arrays, or the like. The controller 300 is connected with various components of the deterrent device 100 by lines in FIG. 7 that represent wired and/or wireless connections.

A sensing array 302 of the deterrent device 100 represents one or more sensors 304, 306 that operate to detect pests or people. A pest can be an animal whose presence near the device 100 is sought to be detected and/or deterred by the device 100. The sensing array 302 can include one or both of the sensors 304, 306, or optionally may include one or more other sensors. The sensor 304 includes an infrared (IR) sensor that detects IR wavelengths of light or heat to sense the presence of a pest. This can prevent the sensor 304 from incorrectly identifying movement by an inanimate object or non-animal object as a pest. The IR sensor 304 can be a passive IR sensor in one embodiment.

The sensor 306 can include an optical sensor, such as a camera, that detects motion to sense the presence of a pest. Alternatively, the sensor 306 may be a camera that records images and/or videos responsive to detection of a pest. For example, the sensor 306 can record images and/or videos when a pest is detected and communicate the images and/or videos (to a mobile device 334 via a communications array 326, as described below) so that the pest can be viewed. The sensor 306 may be able to record images and/or videos during daytime or night.

Optionally, the sensing array 302 can include one or more other sensors, such as an accelerometer (e.g., to sense vibrations caused by nearby movement of a pest), a thermometer or thermocouple (e.g., to sense changes in temperature brought about by the presence of a pest), a radar sensor, a microphone, or the like, that operate to detect the presence of a pest. The sensors 304, 306 in the sensing array 302 can communicate signals indicative of detection of a pest or other object near the deterrent device 100 (e.g., within a sensing range of the sensors 304, 306).

The deterrent device 100 includes a repelling array 308 that represents or includes one or more devices that operate in response to detecting the presence of a pest nearby. The repelling array 308 can include a speaker 310 that is controlled by the controller 300 to generate sounds in response to detecting the presence of a pest (e.g., person or animal) using the sensing array 302. The controller 300 can direct the speaker 310 to generate a variety of sounds, such as a pre-recorded animal sound (e.g., growling), person sound (e.g., a person yelling), an explosive sound (e.g., an explosion, gunshot, etc.), a loud sound (e.g., a constant or varying pitch sound), and/or a recordable sound. With respect to the recordable sound, the controller 300 and/or speaker 310 shown in FIG. 7 also can represent a tangible and non-transitory computer readable medium (e.g., a computer memory) on which a user of the deterrent device 100 can record sounds to be played via the speaker 310 upon detection of a pest.

The repelling array 308 optionally can include a pump assembly 312 that represents a reservoir and one or more pumps. The pump assembly 312 can be activated by the controller 300 responsive to detection of a pest to expel one or more fluids (e.g., liquids and/or gases) to drive the detected pest away. The fluids can include chemicals having smells that drive the pest away, water that is sprayed to scare the pest away, dyes or inks to mark the pest that is near the deterrent device 100, or the like.

The repelling array 308 optionally can include one or more motors 314 (e.g., one or more servo motors) that are activated by the controller 300 in response to the sensing array 302 detecting a pest. The motor or motors 314 can be activated to generate movement of some part of the deterrent device 100. For example, a motor 314 can couple the head or face segment 104 of the housing 102 with the body segment 106 of the housing 102. The motor 314 can be activated to move the head or face segment 104 relative to the body segment 106. For example, the motor 314 can at least partially rotate the head or face segment 104 relative to the body segment 106, can move the head or face segment 104 up and/or down, left and/or right, etc., relative to the body segment 106. This movement also can scare or drive away the detected pest.

Optionally, the repelling array 308 can include one or more light-generating devices 108 (shown in FIG. 1), such as light emitting diodes, incandescent light bulbs, fluorescent lights, or other lamps. These light-generating devices 108 can be activated in response to detecting the presence of a pest. This can assist in scaring or driving the pest away, especially in low- or no-light conditions.

The deterrent device 100 optionally can include a power management assembly 316 that supplies electric current to power one or more (or all) of the components of the deterrent device 100. In the illustrated example, the power management assembly 316 includes an energy storage device, such as a battery 318. The battery 318 can be charged from one or more sources of electric current so that the deterrent device 100 can be powered without having a hard wire connection to an external power source. A connector 320, such as but not limited to a universal serial bus (USB) connector, can be used to charge the battery 318 and optionally to communicate with the controller 300 (e.g., to connect an external device, such as a phone, microphone, etc., for downloading and/or recording sounds).

The power management assembly 316 may include charging circuitry 322 that conductively couple the connector 320 with the battery 318 and that can control conduction of electric current to the battery 318. For example, the charging circuitry 322 can control the conduction of current to the battery 318 to prevent the battery 318 from being damaged from surges, from overcharging, or the like. The charging circuitry 322 can represent diodes, switches, inductors, capacitors, or the like, to control conduction of the current to the battery 318. The battery 318 can be conductively coupled with the other components described herein to provide current to and power the components. In one example, the battery 318 includes a lithium ion rechargeable battery, but optionally can represent one or more other types of batteries.

The power management assembly 316 optionally can include a solar panel 324 that represents one or more photovoltaic bodies. The solar panel 324 can receive light and convert at least some of the light into electric current. This electric current can be conducted (e.g., through the charging circuitry 322 or directly) to the battery 318 for charging the battery 318. The charging circuitry 322 can include one or more switches that control which source the battery 318 receives current from (e.g., the connector 320 or the solar panel 324).

The deterrent device 100 can include a communications array 326 that is controlled by the controller 300 to communicate (e.g., transmit, broadcast, and/or receive) signals with one or more devices that are external to the deterrent device 100. The communications array 326 can include several wireless devices that wirelessly communicate with one or more external devices. For example, the communications array 326 can include a short-range radio 328 that wirelessly communicates with external devices over shorter distances (e.g., less than 100 meters, less than 20 meters, or less than 10 meters). This short-range radio 328 can be a BLUETOOTH low energy (BLE) radio in one embodiment. Optionally, the short-range radio 328 may be BLUETOOTH (e.g., not low energy BLUETOOTH) or another wireless device.

The communications array 326 can include a wireless transceiving circuitry 330 that communicates wirelessly over longer ranges than the short-range radio 328. In one embodiment, the wireless transceiving circuitry 330 includes one or more antennas, modems, and the like, for communicating using Wi-Fi protocols. The wireless transceiving circuitry 330 can allow the deterrent device 100 to communicate with home wireless networks, mobile hotspots, or the like.

The communications array 326 can include a location device 332 that wirelessly communicates with one or more external devices to determine a location of the deterrent device 100. In one example, the location device 332 is a GPS receiver. Alternatively, the location device 332 can include an antenna and circuitry that receives or emits beacon signals useful in determining the location of the deterrent device 100. Optionally, the location device 332 can represent a cellular transceiver that communicates cellular signals with one or more cellular towers or devices. This cellular transceiver can be used to triangulate the location of the deterrent device 100. Optionally, the cellular transceiver can be used to wirelessly communicate data signals to convey other information to and/or from the deterrent device 100.

One or more of the devices of the communications array 326 can be used to communicate with and/or locate the deterrent device 100. The location device 332 can determine the location of the deterrent device 100, the short range radio 328 can communicate with a mobile device 334 (e.g., a cell phone, a tablet computer, etc.) for locating the deterrent device 100 to a user 336 of the mobile device, or the like. The location that is determined can be communicated from the controller 300 to the mobile device 334 or another device for locating the deterrent device 100 (e.g., via signals sent from the short-range radio 328 and/or wireless transceiving circuitry 330). The location of the deterrent device 100 can be displayed (e.g., on a map) on the mobile device 334.

The deterrent device 100 can wirelessly communicate with the mobile device 334 to allow for remote control of the deterrent device 100. This remote control can allow for a user to provide input to the mobile device 334 while far away from the deterrent device 100 to change the repellant or repellant action being provided by the repellant array 308 responsive to detection of the pest. For example, the mobile device 334 can wirelessly communicate an instruction, signal, or the like, to remotely change which sound is played by the speaker 310 upon detection of a pest, to remotely change the volume at which the sound is played by the speaker 310 upon detection of the pest, to remotely record a new sound to be played by the speaker 310 upon detection of the pest, to remotely change whether a sound is played, a chemical is sprayed, a light is activated, and/or the motor 314 is activated, etc.

Optionally or alternatively, the mobile device 334 can be used to remotely activate one or more components of the repellant array 308 even if the sensing array 302 does not detect the presence of a pest. For example, a user can provide input on the mobile device 334 to direct or otherwise cause the speaker 310 to play a sound, to direct or otherwise cause the pump assembly 312 to spray a chemical, to direct or otherwise cause the motor 314 to begin moving, to direct or otherwise cause a light to be activated, etc.

The mobile device 334 may provide a display for images and/or videos recorded or otherwise obtained by the camera 306. For example, the images and/or videos can be sent to the mobile device 334 via the communications array 326 to allow for the user to view the images and/or videos on the mobile device 334. The images and/or videos can be sent to the mobile device 334 in real time (e.g., as the images and/or videos are recorded) and/or in non-real time (e.g., upon request from the user via the mobile device and/or at times dictated by a schedule, availability of a network, etc.). The user can remotely view the images and/or videos on the mobile device 334 and provide input to the mobile device 334 to remotely direct or cause the repelling array 308 to perform one or more repelling actions, as described herein.

Optionally, two or more of the deterrent devices 100 can communicate with each other using the short-range radio 328 and/or the wireless transceiving circuitry 330. For example, the deterrent devices 100 can communicate signals with each other via the communications array 326 (directly or indirectly via mobile devices 334, networks, etc.). The controllers 300 of the deterrent devices 100 can communicate with each other to coordinate operations of the deterrent devices 100 with each other. For example, responsive to one deterrent device 100 detecting the presence of a pest nearby, the controller 300 of that deterrent device 100 can communicate a warning signal to other deterrent devices 100 and/or the mobile device 334 to notify and/or warn of the presence of the pest. The several deterrent devices 100 can then generate sounds, flash lights, move portions of the housings 102, spray liquids, etc. responsive to at least one (but not necessarily all) of the deterrent devices 100 detecting a pest. This can allow for multiple deterrent devices 100 to scare off or repel a pest even when less than all of these deterrent devices 100 detect the pest. The controller 300 optionally can communicate notification signals to mobile devices 334 and/or other deterrent devices 100 to notify a user that the deterrent device 100 is running low or out of stored energy, a chemical to spray, or the like.

The communications array 326 can communicate data signals with the mobile device 334 and/or other devices to download and/or upload additional sounds to play via the speaker 310 when a pest is detected. The communications array 326 can communicate data signals with the mobile device 334 and/or other devices to download and/or upload additional sounds to play via the speaker 310 when a pest is detected.

The communications array 326 can communicate with the mobile device 334 and/or other devices to activate (e.g., turn on) or deactivate (e.g., turn off) the controller 300 of the deterrent device 100. The controller 300 can communicate charge signals with the mobile device 334 via the communications array 326 to notify the user 336 of the state or level of charge in the battery 318. For example, the controller 300 can communicate a warning of a low state of charge of the battery 318 to the mobile device 334 via the communications array 326. The controller 300 can direct the communications array 326 to send a warning signal to the mobile device 334 to warn or notify the user 336 of a variety of events, such as detection of a pest, one or more responsive actions taken (e.g., movement by the motor 314, spraying of a fluid by the pump assembly 312, generation of sound by the speaker 310, etc.). The controllers 300 of several deterrent devices 100 can notify the user 336 of the locations of the deterrent devices 100 and the times at which a pest was detected by the deterrent devices 100 so that the mobile device 334 can track movement of the pest.

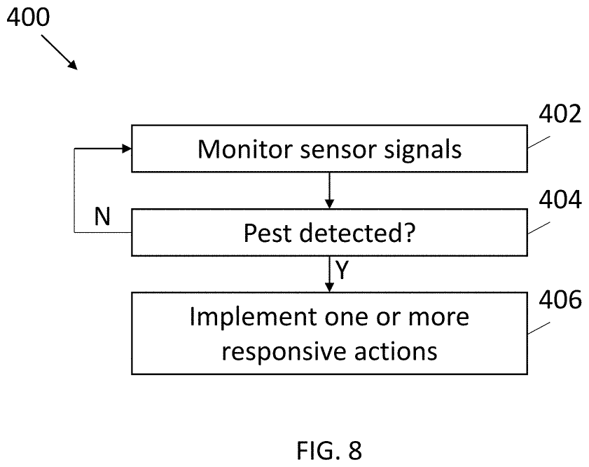

FIG. 8 illustrates a flowchart of one embodiment of a method 400 for detecting and responding to the presence of a pest. The method 400 can represent at least some of the operations performed by one or more embodiments of the deterrent device 100 described herein. At 402, sensor signals are monitored. For example, the signals from an IR sensor, a radar system, a microphone, etc. can be repeatedly and/or continuously monitored to determine whether these signals indicate the presence of a pest. At 404, a determination is made as to whether the sensor signals indicate the presence of a pest. For example, responsive to the IR sensor generating signals indicating detection of a warm body nearby, responsive to the radar system generating signals indicating detection of a moving body nearby, responsive to the microphone generating signals indicating detection of sounds, etc., the presence of a pest (e.g., animal, person that is intruding on a space, etc.) can be detected. If the sensor signals indicate the presence of a pest, flow of the method 400 can proceed toward 406. Otherwise, flow of the method 400 can return toward 402 so that additional sensor signals can be monitored. At 406, one or more responsive actions are implemented upon detecting the presence of the pest. For example, a camera may record images and/or video. A motor may move part of the deterrent device. A pump may spray a fluid. A speaker may generate a sound. Lamps may be activated to generate light. The responses can be generated to scare or drive away the pest and/or to notify others of the pest.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A pest deterrent device comprising:
one or more sensors configured to detect a presence of a pest;
a controller configured to determine that the pest is detected based on output from the one or more sensors;
a repelling array configured to generate a repellant in response to the controller determining that the pest is detected; and
a communications array configured to wirelessly communicate with an external device, the communications array configured to communicate with the external device to change a type of the repellent that is generated in response to the pest being detected.

2. The pest deterrent device of claim 1, wherein the one or more sensors, the controller, the repelling array, and the communications array are disposed within a housing having a shape of an animal.

3. The pest deterrent device of claim 1, wherein the one or more sensors include an infrared sensor configured to detect the presence of the pest.

4. The pest deterrent device of claim 1, further comprising a camera configured to record one or more of an image or a video responsive to the presence of the pest being detected, and wherein the communications array is configured to wirelessly communicate the one or more of the image or the video to the external device.

5. The pest deterrent device of claim 1, wherein the repelling array includes a speaker configured to generate a sound in response to the pest being detected as the repellant, and wherein the communications array is configured to communicate with the external device to one or more of: (a) remotely change the sound that is generated in response to the pest being detected or (b) remotely change a volume of the sound that is generated in response to the pest being detected.

6. The pest deterrent device of claim 5, wherein the controller is configured to receive a customized recording for the sound from the external device via the communications array.

7. The pest deterrent device of claim 1, wherein the repelling array includes a pump assembly configured to spray a liquid in response to the pest being detected.

8. The pest deterrent device of claim 1, wherein the one or more sensors, the controller, the repelling array, and the communications array are disposed within a housing and the repellant array includes a motor configured to move a segment of the housing responsive to the pest being detected.

9. The pest deterrent device of claim 1, wherein the communications array is configured to communicate with the external device to notify a user of the external device of detection of the pest.

10. The pest deterrent device of claim 1, wherein the communications array is configured to communicate with another pest deterrent device to notify the other pest deterrent device of detection of the pest.

11. The pest deterrent device of claim 1, further comprising a location device configured to determine a location of the pest deterrent device, wherein the communications array is configured to communicate the location to the external device.

12. The pest deterrent device of claim 1, further comprising a solar panel configured to supply electric current to power the controller, the repelling array, and the communications array.

13. A pest deterrent device comprising:
an outer housing;
an infrared (IR) sensor disposed on or within the outer housing, the IR sensor configured to detect heat indicative of a pest;
one or more processors disposed in the outer housing and configured to detect a presence of the pest based on the heat detected by the IR sensor;
a repellant device configured to generate a repellant responsive to the presence of the pest being detected; and
a communication device configured to wirelessly communicate with a mobile device, the communication device configured to receive instruction from the mobile device to remotely change the repellant that is generated by the repellant device responsive to the presence of the pest being detected.

14. The pest deterrent device of claim 13, wherein the repellant device includes one or more of:
a speaker configured to generate a sound in response to the presence of the pest being detected;
a pump configured to spray a chemical in response to the presence of the pest being detected; or
a motor configured to move a first segment of the outer housing relative to a second segment of the outer housing in response to the presence of the pest being detected.

15. The pest deterrent device of claim 13, further comprising a camera configured to record one or more of an image or a video responsive to the presence of the pest being detected.

16. The pest deterrent device of claim 13, wherein the one or more processors are configured to receive, from the mobile device, a customized recording for a sound that is generated as the repellant.

17. The pest deterrent device of claim 13, wherein the communication device is configured to communicate with another pest deterrent device to notify the other pest deterrent device of detection of the pest.

18. A method comprising:
detecting a presence of a pest outside of an outer housing of a pest deterrent device using an infrared (IR) sensor;
generating a repellant in response to detecting the presence of the pest; and
wirelessly communicating with an external device to remotely change the repellant that is generated in response to detecting the presence of the pest.

19. The method of claim 18, wherein generating the repellant includes one or more of:
generating a sound using a speaker of the pest deterrent device in response to the presence of the pest being detected;
spraying a chemical from the pest deterrent device in response to the presence of the pest being detected; or
moving a first segment of the outer housing relative to a second segment of the outer housing in response to the presence of the pest being detected.

20. The method of claim 18, further comprising:
wirelessly communicating a warning of a low state of charge of a battery of the pest deterrent device to the external device.
